(19) United States
(12) Patent Application Publication
(10) Pub. No.: US 2012/0301593 A1
(43) Pub. Date: Nov. 29, 2012

(54) Use of extracts of pineapple as flavor intensifiers

(76) Inventor: LaWanda Kelly, (US)

(21) Appl. No.: 13/507,714

(22) Filed: Jul. 23, 2012

Related U.S. Application Data
(63) Continuation-in-part of application No. 12/230,410, filed on Aug. 28, 2008.
(60) Provisional application No. 60/935,935, filed on Sep. 7, 2007.
(60) Provisional application No. 61/064,218, filed on Feb. 22, 2008.

(51) Int. Cl. A23L 1/222; A23L 2/56

(52) U.S. Cl. 426/597; 426/650; 426/590; 426/615; 426/655

(57) ABSTRACT

The enhancing/flavoring products containing either extracts of pineapple or artificial pineapple flavorings in concentrated form to be used in a wide variety of food products, including drinks such as teas, deserts, glazes for meat products and salad dressings. In the products of the invention there is usually not taste of pineapple identified.

This patent application is a continuation-in-part of U.S. patent application Ser. No. 12/230,410 filed Aug. 28, 2008, which takes priority from Provisional Application 60/935,935 filed Sep. 9, 2007 and 61/064,218 filed Feb. 22, 2008.

### FIELD AND BACKGROUND OF THE INVENTION

This invention relates to the use of pineapple extracts in food products in combination with at least one other flavoring to provide products having intensified flavor but lacking noticeable pineapple flavor. Many of the products of the invention have intensity of flavor usually expected in liqueurs and so can be used as after dinner dessert drinks. The products disclosed herein may also be used as replacements for liqueurs for addition to marinades for fish or meats and can also replace liqueurs in desserts such as trifles or compotes. The products may also be used in more dilute forms as soft drinks or teas. The more concentrated products may be used over shaved or crushed ice for iced treats such as snow cones. The “snow” in the cones have unique and complex flavors.

Unlike many prior art products, the drinks of the present invention do not use pineapple juice, but only extracts, nor do they require alcohol to intensify flavors and modify flavors. In other words, that which is squeezed from the fresh pineapple is not used in the products of the invention. Only that which has been extracted with heating is useful. However, it has also been found that artificial flavorings normally sold commercially can be used in place of juice extracted from pineapple. For example, the product obtained from FAERIE'S FINEST™ contains artificial flavorings. What must not be used is the juice of the raw pineapple.

Other fruit flavors have been used to impart a flavor not usually identified with the fruit flavor used. Products containing plum juice to produce beverages which taste like cola, but lack kola nut extract or cola flavoring have been described in U.S. Pat. No. 4,612,205 to Kupper, et al. The final products described in the patent are carbonated beverages. Kupper teaches that many other fruit juices, in addition to plum juice, can be added to the carbonated products described and claimed by Kupper, et al., including pineapple juice. There is no disclosure therein to use extracts of pineapple.

U.S. Pat. No. 5,780,086 to Kirksey, et al. teaches shelf stable beverages containing tea extracts which may, additionally, contain small amounts of fruit juices and fruit juice concentrates. There is no teaching therein that use of pineapple extracts should be used in such teas. In fact, the pineapple juice is identified in a long list of possibilities. There is no teaching therein to use pineapple extract to enhance or modify other flavorings to effect intensity of other flavors.

U.S. Pat. No. 7,087,259 to Wild, et al. teaches teas containing tea extracts and extracts of grape skins and grape seeds. The teas may contain extracts of other fruits, including papaya or pineapple extracts. The products of Wild, et al., are primarily used for their high polyphenol content. The fruit extracts are used in small amounts. There is no teaching to make products wherein the primary flavorings are tea and pineapple extract.

U.S. Pat. No. 6,838,092 to Mercati teaches making of effervescent compositions containing dried fruit juices. He discloses, as his preferred embodiment, drying an edible plant juice, then freeze drying.

U.S. Pat. Nos. 4,996,070 and 6,838,092 to Nafisi-Movaghar teach fruit flavored extracts. Those extracts made by infusion may have used in the preparation of products described herein.

U.S. Pat. No. 5,902,622 to Owusu-Ansah, et al. teaches a process for making extracts of various plant products for use in baking. While the products of that patent may be used in making the products of the invention claimed herein, there is no teaching therein to make the drinks as disclosed in this application.

Recipes for drinks made with pineapple juice are widely available on the interne and in cook books. Many require other ingredients used in the methods of the invention. One drink made with rum using canned pineapple has been described in the prior art. However, the method of making and the use of rum result in a very different product.

### SUMMARY OF THE INVENTION

It is the purpose of this invention to provide food products of intense flavor using pineapple extracts and at least one additional flavoring product such as fruits, fruit extracts, nut extracts, spices or teas, wherein the final products have intensified flavor but lack discernable pineapple flavor. The enhancing/flavoring products of the invention may be sold in concentrated form to be used in a wide variety of food products. Particularly preferred for a wide variety of uses are products containing both pineapple and lemon extracts.

### DETAILED DESCRIPTION OF THE INVENTION

It has now been found that it is possible to make products containing pineapple extracts in which the pineapple extracts impart intensity of flavor to the final product. The products of the invention can be sold in a wide variety of concentrations for varying uses. The products have an intensity of flavor usually associated with liqueurs. Because many persons, either for religious or health reasons, do not use food or drink products containing alcohol, it is desirable to have products of intense flavor that can be used in place of liqueurs. The discovery that pineapple extracts will provide products of intense flavor without imparting a distinctively pineapple flavor provides means for making products having such intense flavors.

For purposes of this application, the term “extract” is any product in which flavor has been extracted from a flavoring material into a liquid. The liquid in which canned fruit has been processed during canning is, for purposes of this disclosure, an extract. The “extract” may be quite diluted, as when used as a soft drink or punch, but more concentrated products may be used in smaller amounts as after dinner drinks to replace liqueurs. The products of the invention may also be used, for example, in desserts in place of liqueurs and as a syrup over chipped or shaved ice. The term “steep” is used herein in the usual manner, namely, as to soak in a liquid to extract flavor. The concentrated products of the invention may be used to make beverages by addition of carbonated or still (non-carbonated) water.

Desserts of any kind in which one would use fruit juice or liqueurs may be made with the products of this invention, including, but not limited to, trifles, cakes, dessert crepes, fruit compotes, puddings, soufflés and gelatins. The more concentrated products may be used as syrups on pancakes, waffles and such.

While it is possible to use juice obtained when pineapple has been cooked or steeped in a heavy syrup, it is more convenient to use commercially available pineapple extract, including products containing large amounts of sugar which may be available as syrups. Pineapple syrup is less available than other syrups, and was ordered directly from the manufacturers. TORANI™ brand syrups, available through California Coffee Roaster of Del Valle, Tex., were used in some examples. The beverages resulting from use of pineapple syrup, whether prepared from concentrated syrup available commercially, prepared by cooking or steeping the pineapple in sugar and water, or with the use of extracts, have a distinct flavor and appearance quite different from those made with pineapple juice. Extracts are available from several sources, including McCORMICK™, of Hunt Valley, Md. and FAERIE'S FINEST™, of Hawaiian Gardens, Calif., which are extracts used in the examples.

Pineapple syrup (an extract) may be made by cooking pineapple in water containing sugar or the pineapple may be steeped for from several hours to 3 days in water containing a large amount of sugar. However, pineapple juice, as opposed to extract, whether reconstituted from frozen concentrate or fresh, does not produce a product having the characteristics of the products of the invention. When practicing the instant invention using canned pineapple, the pineapple sinks to the bottom of the mixture and may, thereafter, be separated from the liquid component and used in desserts. When fruit is used in making a product, the fruit has a very intense flavor and can be used in many ways, such as for topping on dessert. The fruits which have been part of the fruit/pineapple extract mixture have a more complex flavor than the original fruits.

Pineapple extract can be used in combination with flavors other than fruits and fruit extracts. Lemon is a particularly useful flavoring and may be combined with other fruits such as berries or their extracts, spices or nuts. In any instance, extracts may be used in place of the nuts or fruits. Most preferred mixtures of extracts are those containing, in addition to pineapple, at least some lemon, with preferred products having 1:3 to 3:1 amounts of pineapple to lemon in the final product, though, because of variation in intensity of different extract products a range of 1:10 to 10:1 pineapple to lemon may be used. Extracts of nuts such as hazel nut, pecan or almond may also be used in the method of the invention. When adding nut extracts, the ratio of nut extract to pineapple extract is 1:1 to 1:15, since most nut extracts are quite strong. Spices can also be added for flavor for use in drinks, desserts or baked items. While any spice may be used, either as an integral part of the enhancing composition or added at the time of use, anise, cardamom, ginger and cinnamon are particularly useful.

Some products of the invention may be used in the form of a tea or citrus drink to replace other teas or sodas. For purposes of this invention, green tea is not acceptable, since it gives a rather medicinal taste. Oolong and black tea were the most palatable for use with the products of the invention with black teas being the most preferred. The products may be used to make fruit punch which can be colored or flavored with other additional fruits such as berries. Berries particularly useful for punch include blueberries, raspberries, blackberries, grapes and strawberries. Sparkling liquids such as seltzer water or ginger ale may be added. If fruit used in a product can be separated from the final product, such fruit usually has absorbed some of the flavoring of the other components in the mixture, whether tea or fruit product, and can be removed and used for topping for desserts such as ice cream or cakes. Any fruits removed from the liquid may also be used in cake fillings.

To make the teas the desired teas are steeped in water for sufficiently long period of time to impart strong flavor. After steeping the tea, the compositions containing pineapple extracts may be added. The flavor of the resulting product is intense but the typical pineapple flavor is not noted. As exemplified, the more heavily flavored extracts with a smaller ratio of sugar to extract such as those of example 22 are most preferred for adding to teas, since there is variation in amount of sweetness each individual would want. The enhancers of the invention can be added to either hot or cold tea.

One method of making the tea drink comprises using as the extract the liquid with the canned pineapple. More convenient are the products to which extracts such as those available commercially have been added. Water and sugar are added to taste to provide the refreshing drink. Powdered flavorings may be added, but must be used with care. Black cherry powdered drink flavoring such as KOOL AID™ was, in one of the examples, used in very small quantities to provide added flavor. (Because such powdered flavorings are very strong, they are used in very small quantities.) However, any fruit flavor may be used in place of the black cherry.

In one method of making tea, the tea is brewed in about 10 to 15% of the amount of water suggested in the instructions to produce a concentrated tea. It is brewed in very hot water for at least 15 minutes. The percentages of the ingredients (by volume), when made by one method of the invention, are as follows:

| | |
|---|---|
| Pineapple in heavy syrup: | 10-22% |
| Sugar: | 3-12% |
| Concentrated tea prepared as above | 8-15% |
| Water: | 55-80% |

If less sweetness is desired, the sugar may be omitted completely.

If one desires, the pineapple extract, artificial pineapple flavoring or syrup can be made from fresh cooked pineapple. In that case, the core and the skin are removed from the pineapple. The pineapple is then cut into small chunks. A syrup is made with using ½ to ¾ cups of sugar in about ⅛ to ½ cups of water, which is gently cooked until the sugar dissolves. The pineapple chunks are mixed with the syrup and the mixture is allowed to steep for 4 hours to 2 days. The extract-containing solution produced is about 20 ounces, and is used in place of the similar amount of liquid (extract) from canned pineapple.

When the invention is practiced using concentrated pineapple liquid extracts such as those commercially available, the additional flavoring is present within a 1:10 to 10:1 pineapple extract to other flavorings used. When a juice such as lemon juice is used with a dilute pineapple extract such as that disclosed in examples 2 and 3, the amount of other flavoring may be as little as 50:1 of liquid pineapple extract to additional liquid favoring ingredients. When powders (including spices) are used as flavoring, as little as 1:10000 of powder flavorings to liquid final product may be used. (See example 4).

While the liquid obtained from steeping or cooking pineapple may be used, as exemplified below, the products of the invention may be made using commercially available extracts and syrups. Use of the commercial extracts gives a more predictable final product In preferred embodiments of the invention, the pineapple extract made using commercial products are usually presents≦10% in the final product. Products made using such extracts can be quite concentrated. They can be added to dessert products to provide intense flavor. The intensity of flavor using such products approaches the intensity of flavor found in liqueurs. The flavorings my include, for example, apple, cranberry, pear, peach, plum, apricot, nectarine, grape, cherry, currant, raspberry, gooseberry, blackberry, blueberry, strawberry, lemon, lime, mandarin, orange, grapefruit, coconut, pomegranate, kiwi, mango, papaya, banana, watermelon, tangerine and cantaloupe. These fruit flavors can be derived from natural sources such as fruit juices and flavor oils, or else be synthetically prepared. Other fruit or nut flavorings not specifically identified herein may also be added to products disclosed herein without departing from the spirit of the invention.

While sucrose has been the sweetener used in the examples below, other sweeteners may be used. The carbohydrate sweetener is preferably a mono- and or disaccharide sugar such as maltose, sucrose, glucose, fructose, invert sugars and mixtures thereof. These sugars are also provided to some extent by other added materials in the beverage product such as fruit juice, optional flavorings such as syrups and so forth. Fructose for use in the beverage product can be provided as liquid fructose, high fructose corn syrup, dry fructose or fructose syrup, but is preferably provided as high fructose corn syrup comprising at least about 50% by weight of fructose. For diet beverages, non-caloric sweeteners can be used. Examples of such sweeteners include aspartame, saccharine, cyclamates, acetosulfam, L-aspartyl-L-phenylalanine lower alkyl ester sweeteners, L-aspartyl-D-alanine amides.

The amount of sweetener effective in the beverages of the present invention depends upon the particular sweeteners used and the sweetness intensity desired. For non-caloric sweeteners this amount varies depending upon the sweetness intensity of the particular sweetener. The amount for artificial sweeteners in the final product when used as a beverage generally ranges from about 0.0001% to about 0.1%.

If greater tartness to taste is desired, acids such as phosphoric acid suitable for use in the beverage of the present invention include citric, malic, tartaric, lactic, formic, ascorbic, hydrochloric, sulfuric, fumaric, and adipic. Preferred for use herein is a phosphoric acid. The acid is used in solution form in an amount of from about 0.01% to about 0.5% by weight of the beverage, preferably from about 0.05% to about 0.25% by weight of the beverage, depending upon the acidulant used.

Benzoic acid, sodium benzoate, or other suitable compounds can be added as a preservative. The level of preservative used is adjusted according to the planned final product pH, as well as an evaluation of the microbiological spoilage potential of the particular beverage medium. The maximum level employed is about 0.05% by weight of the product.

### Example 1

### Preparation of Fresh Pineapple for Use in Method of the Invention

To 2 cups of fresh pineapple (cored and pealed and cut into small chunks) was added ⅔ cup sugar which has been dissolved over heat in 2 tablespoons of water with occasional mixing. This was allowed to steep for 2 days.

### Example 2

### Preparation of Tea Drink

To make 18 quarts of the tea drink:

A tea concentrate is made using 4 large tea bags (Lipton orange pekoe tea, each bag being sufficient to make 1 gallon of tea) and 32 ounces of boiling water. This is allowed to steep until the tea is cooled, when the bags are removed.

Using canned pineapple (not crushed), 5 20-ounce cans of canned pineapple (not crushed) were placed into a large (at least 20 quart) container, then crushed slightly. Eight cups of sugar were added, then 8 cups of the tea concentrate prepared as above. One tablespoon of lemon juice was added (optional) and water was added to make 18 quarts.

### Example 3

### Drink with Fresh Pineapple

The above method was used but as replacement for the crushed canned pineapple, each 20 ounce can of pineapple is replaced with the fresh pineapple/sugar mixture made in Example 1.

Comparing the product made with extract from the fresh pineapple with that made with canned extracting liquid (the liquid in the can of the canned pineapple), the product using extract prepared from the fresh pineapple was a little less sweet, but very similar.

### Example 4

### Flavoring Added: Black Cherry

To 1 quart of the drink produced in Example 2 was added ¼ teaspoon of black cherry (KOOL AID™) drink flavoring.

### Example 5

### English Breakfast Tea

Steeping: Six tea bags were placed in one quart of water that has been heated to boiling. After the liquid had cooled, the bags were removed. Three quarts of water was then added to the tea to make 1 gallon of tea. 1½ cups of sugar was added to the tea along with 1 tablespoon lemon juice and ¼ teaspoon of black cherry drink flavoring. The tea was mixed thoroughly to dissolve the sugar. After sugar had dissolved, 1 20 ounce can of pineapple in heavy syrup was added to the tea and gently pressed, then the whole is stirred carefully.

The drinks made with citrus by the methods of the invention, while different from the teas, are also quite different from other citrus products when made with pineapple extract in the manner of the invention rather than with pineapple juice. The product from which the pineapple chunks have been removed makes an excellent fruit punch. The pineapple removed from the drink makes a fine topping for cakes, puddings and custards. The range of ingredients in the lemon drinks are in the range of

| | |
|---|---|
| Lemon juice | 1.5 to 4% |
| Sugar (dry measure to final volume) | 3 to 13% |
| Pineapple chunks in heavy syrup | 15 to 30% |
| Water | 50 to 80% |

The sugar is measured as dry ingredient. The resulting products made with citrus have a citrus flavor, but the flavor is also much more intense and complex.

### Example 6

To freshly squeezed juice of 6 lemons was added six cups of sugar and 8 quarts of water. After stirring, 108 ounces (6 pounds, 12 ounces) pineapple chunks in heavy syrup were added. After mixing, the pineapple, which had settled, was gently squeezed with a masher to release flavor without breaking the pineapple into small pieces. Four more quarts of water were then added along with ½ ounce of raspberry flavoring extract and the whole was mixed gently to provide an intensely flavored drink. This drink is very intense, and may be diluted.

### Example 7

A tea was made in the manner of Example 2, except that the tea used was Earl Grey tea. The tea was rather bitter and required more sugar.

### Example 8

A drink was made in accord with the teaching of example 6, except that the lemon was replaced with lime juice. The flavor of the resulting product was weaker than the product made with the lemon juice.

It was found that many of the drinks made in accord with the above examples were, to the taste of many, excessively sweet. Furthermore, in making lighter versions of the drinks, the adjustments in sugar content are accompanied by decreased amounts of tea used in making the tea drinks.

### Example 9

A drink was made in accord with the Example 2. The amounts used are:

Two large (restaurant size) tea bags steeped in 32 ounces of boiling water. Fifty ounces of canned pineapple in heavy syrup were lightly mashed to gently crush the pineapple, one tablespoon of Real Lemon Juice was added and the whole is diluted to provide 18 quarts of drink.

### Example 10

A lighter drink was made by the method of example 6, except that no sugar was added.

### Example 11

A drink was made in accord with the teachings of Example 6. However, no sugar was added and twice the amount of water (8 cups) was added to the pineapple/lemon juice mixture. The drink was less intense and very refreshing

### Example 12

A drink was made having juice of 6 lemons, 5 cups of heavy syrup from canned pineapples, 12 quarts of water, 3 tablespoons of Real Lemon juice, three cups of sugar and 2½ cups of fresh strawberries, crushed. The resulting product had an intense flavor appropriate for after dinner drink (a small amount). It was diluted with water to a ration of drink product to water of 1:2. This drink was appropriate for use as a very refreshing punch.

### Example 13

A drink was made in accord with example 12, except that the strawberries were replaced with 1 fluid ounce strawberry syrup.

### Example 14

A drink in accord with Example 13 was made except that, instead of 12 quarts of water, 20 quarts of water is added to provide a lighter product.

Other flavors may be used in replacement for the strawberry syrup such as blueberry, cherry (including black cherry), grape and blackberry. The flavors blend so that the citrus, tea or berry (grapes being considered, for purposes of this disclosure, to be berries) tastes often can be identified, but the pineapple taste is not identified as such.

### Example 15

A tea was made. To 4 cups of brewed tea made in accord with the teachings of Example 2, but there was added an additional 4 cups of water during brewing, After brewing there was added one fluid ounce of coconut extract, one fluid ounce of coconut syrup, 4 cups of heavy syrup from canned pineapples along with pineapple (about 5 cups) and 4 tbsp. REAL LEMON™ juice and sugar to taste.

This rich drink may be diluted at 1:2 to 1:10 of product as prepared above to tea made with boiling water as suggested on the packaging to make a refreshing drink for a cold night. It may be similarly diluted with cold water and ice or to ice tea for a refreshing drink.

In each case, when drinks are made with the pineapple in syrup, the products are allowed to sit with occasional stirring for several hours before serving. The sweetness increases with time. The drinks, if tightly covered and refrigerated, will remain drinkable for up to two weeks, sometimes more. When the drink is allowed to stand for longer periods of time, less sugar is required.

The use of commercially available syrups and other extracts results in the products of the invention having more uniformity and longer shelf life. Hence, it is anticipated that commercial products for wide distribution will be made with such extracts (including syrups). However, the products made with canned or steeped pineapple with bits of the pineapple observable in the mix may be more appropriate for making in small batches close to the time for consumption.

Using commercially available extracts, it is possible to provide highly concentrated products which give the cook great flexibility. A product containing, volume to volume, can be prepared using a 1:1 to 1:5 water to sugar and pineapple extract (commercial product sold as extract) of 0.05% to 5% in conjunction with other flavorings. The product of example 22 falls within that range, with lemon being the co-flavoring extract. As noted above, when powdered flavorings are used, very small amounts of the powder are required.

### Example 16

Two 2 quarts of water which was boiled with 2 cups of sugar followed by cooling. Thereafter 2 fluid ounces of pineapple syrup and 2 fluid ounces of lemon syrup were added to make a drink which was quite intense.

### Example 17

To the mixture of example 16 was added ½ fluid ounce raspberry extract.

Some preferred products of the invention are concentrated products which have multiple uses in the kitchen. Some of the drink products may, of course, be used in making desserts as well as used as after-dinner drinks. However, it is very useful for the cook to have the concentrated products on hand to modify or dilute for varied uses. The following products having several uses can be stored, after opening, in the refrigerator for several days or even weeks. The more concentrated products (see example 22) may be added to icings, frostings and fillings for desserts and to toppings for other desserts. They are particularly useful for addition in very small amounts to fruit to make an easy and interesting dessert.

### Example 18

One cup of water and 1 cup of sugar were boiled together. After cooling, ¼ ounce each of pineapple extract or artificial commercial flavoring and of lemon extract or flavoring were added. The resulting product was appropriate for use as an after dinner dessert drink and for making desserts. (The product was made both with extracts and with artificial flavoring. The use of extract or artificial flavoring of pineapple made little difference. However, lemon extract rather than artificial flavoring gave better products.)

### Example 19

One cup of water was brought to a boil. As it boiled, 2 cups of sugar were added with mixing. After cooling, ½ ounce each of pineapple extract and lemon extract were added. The resulting product would have many uses for desserts or dilution for drinks.

While the composition containing pineapple extract or flavoring may vary widely, depending on the strength of the extract/flavoring, generally a ratio of 50:1 to 5:1 water to pineapple flavoring is acceptable. The water may contain sugar at any ratio desired, but can contain sugar up to the saturation level. Hence, if added to hot water, the ratio of sugar may be increase, as in example 19.

### Example 20

To one tablespoon of the product of example 18 there was added ⅛ teaspoon of cardamom. The resulting mixture was poured over a sliced pear. The resulting product was refrigerated 15 minutes.

### Example 21

A sponge cake (8×8 inches) was soaked in ⅔ cup of the product of example 18. One cup of whipping cream was beaten, then mixed with 1 cup of lemon curd. The soaked cake, whipped cream mixture and raspberries were layered in a bowl to make a trifle, with cake on the bottom and ending with a layer of raspberries.

### Example 22

To ½ cup of the product of example 19 there was added 1 tablespoon each of pineapple extract and 1 tablespoon of lemon to provide a highly concentrated product. The product was particularly useful as an addition to tea or fruit drink.

### Example 23

A trifle was made in the method of example 21. However, 2 tablespoons of raspberry syrup were added to the product of claim 18 before soaking the cake.

### Example 24

One cup of water was brought to a boil. As it boiled, 2 cups of sugar were added with mixing. After cooling, ½ ounce each of pineapple extract and raspberry extract were added. The resulting product would have many uses for desserts or dilution for drinks. It was noted that, compared with Example 19, the composition of this example had more distinct raspberry flavor. It appears that with some flavorings the addition of lemon reduces the distinctive flavor of other components, while lemon extract in some instances increases intensity of flavor.

### Example 25

Chicken breasts and thighs were soaked in the product of example 18 for 30 minutes, then broiled on a grill. During grilling, additional amounts of the product of example 18 were used to baste the chicken.

### Example 25

One half fluid ounce of TORANI™ brand pineapple syrup was placed in a quart container along with the juice of ½ lemon and ¼ fluid ounce of strawberry syrup from the same manufacturer. Cold water was added to make 32 ounces of drink.

The beverages of the invention may also be augmented with vitamins and minerals to provide improved nutrition. Suggested additives would be liposomes containing fat soluble vitamins, water soluble vitamins and electrolytes are examples of appropriate nutritional supplements which may be added.

### Example 26

Pieces of sponge cake (1 pound) were soaked in the product of example 25. Whipping cream (1 cup) was beaten until soft peaks formed. To the whipped cream was added ½ cup of lemon curd with gentle mixing. The sponge cake, flavored whipping cream and fresh raspberries were layered, in that order, in a bowl, beginning with the soaked sponge cake and ending with berries, to provide a trifle.

In order to obtain the concentrate in dry form, water is extracted from the mixed extracts in known manner, preferably by spray drying. Spray drying is an efficient method of transforming liquids to powder. Thus it is possible to obtain a powder having specific physical properties, such as flowability, residual water content, or density. At the same time the properties of the flavoring ingredients present therein can be controlled with reference to quality or release characteristics. However, quality of taste may be lost in the drying in some of the more delicate products such as those containing fresh fruit extracts.

### Example 27

To a compote of 4 plums and 1 pear (all cut in pieces) was added 2 teaspoons of the product of example 22. Neither the pineapple nor the lemon flavor was identifiably discernable, but the product had an intense and complex flavor.

### Example 28

A salad dressing was made using equal amounts of the product of Example 18 and olive oil. Greens were tossed with the dressing.

The appearance of the beverage can be stabilized and enhanced if ascorbic acid, erythorbic acid and citric acid are present in the beverage formula. Erythorbic or ascorbic acid is present in the beverage products of the present invention in an amount of from about 300 ppm to about 1500 ppm. Preferably the beverage products contain from about 300 to about 900 ppm, more preferably from about 400 ppm to about 800 ppm, and most preferably from about 500 ppm to about 750 ppm erythorbic and from about 400 ppm to about 1,200 ppm ascorbic acid.

All of the disclosed products may be used as beverage precursors, with beverages being prepared by addition of water and/or ice or with addition of other drink mixers such as seltzer water or ginger ale. The products of the invention may also be added to mixed drinks.

To a compote of 4 plums and 1 pear (all cut in pieces) was added 2 teaspoons of the product of example 22. Neither the pineapple nor the lemon flavor was identifiably discernable, but the product had an intense and complex flavor.

### Example 28

A salad dressing was made using equal amounts of the product of Example 18 and olive oil. Greens were tossed with the dressing.

The appearance of the beverage can be stabilized and enhanced if ascorbic acid, erythorbic acid and citric acid are present in the beverage formula. Erythorbic or ascorbic acid is present in the beverage products of the present invention in an amount of from about 300 ppm to about 1500 ppm. Preferably the beverage products contain from about 300 to about 900 ppm, more preferably from about 400 ppm to about 800 ppm, and most preferably from about 500 ppm to about 750 ppm erythorbic and from about 400 ppm to about 1,200 ppm ascorbic acid.

All of the disclosed products may be used as beverage precursors, with beverages being prepared by addition of water and/or ice or with addition of other drink mixers such as seltzer water or ginger ale. The products of the invention may also be added to mixed drinks.

What we claim is:

1: A food product containing an extract of pineapple or artificial pineapple flavoring and at least one other flavoring to provide products wherein, in the final product, pineapple is not identifiable to the taste as pineapple.

2: A method of intensifying a flavor by adding thereto a sufficient amount of an extract or artificial flavoring of pineapple to at least one other flavoring to provide an intensified flavoring product.

3: The method of claim 2 wherein the final product is a syrup

4: The product of claim 1 which is a flavoring syrup.

5: The product of claim 1 which is a beverage.

6: The food product of claim 1 containing, as at least one other flavoring, at least one of lemon juice, lemon extract or lemon syrup.

7: The food product of claim 6 containing pineapple and lemon extract or juice and, additionally, at least one other flavoring.

8: A dessert containing at least one product of claim 1.

9: The dessert of claim 8 which is a fruit compote.

10: The dessert of claim 8 containing a nut flavoring.

11: The dessert of claim 10 containing a coconut flavoring

12: The product of claim 1 which contains, additionally, at least one flavoring chosen from spice or nut flavorings.

13: The product of claim 1 containing at least one fruit flavor that is not lemon.

14: The product of claim 1 containing a black or oolong tea.

15: The product of claim 1 which is a concentrated product wherein the pineapple extract is a product commercially as an extract which is present at about 0.05% to 5% in the product.

16: The product of claim 1 which is a drink.

17: The product of claim 1 which is a salad dressing.

18: The method of claim 2 wherein extract of pineapple is a concentrated extract used in amounts of ≦10% in the final product.

19. The product of claim 1 which is a syrup and crushed or shaved ice.

20: The product of claim 1 which is a flavoring enhancer containing water at a ratio of 50:1 to 5:1 water to pineapple extract or flavoring.
